(19) United States
(12) Patent Application Publication
(10) Pub. No.: US 2005/0182834 A1
(43) Pub. Date: Aug. 18, 2005

(54) Network and network device health monitoring

(76) Inventor: Chuck A. Black, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/761,088

(22) Filed: Jan. 20, 2004

(51) Int. Cl. G06F 15/173

(52) U.S. Cl. 709/224; 709/225

(57) ABSTRACT

Systems, methods, and device are provided for device monitoring. One method embodiment includes transmitting a network management message to a device. The method includes collecting response information from the device based on the network management message. The method further includes receiving unsolicited information from the device. The response information and the unsolicited information are analyzed according to a set of heuristics to provide a health measurement of the device.

### BACKGROUND

Computing networks can include multiple network devices such as servers, desktop PCs, laptops, and workstations, among other peripheral devices, e.g., printers, facsimile devices, and scanners, networked together across a local area network (LAN) and/or wide area network (WAN). A LAN and/or WAN uses clients and servers that have network-enabled operating systems such as Windows, Mac, Linux, and Unix. An example of a client includes a user's workstation. The servers can hold programs and data that are shared by the clients in the computing network. Servers come in a wide range of capacities and costs from Intel-based PC servers to mainframes. A printer, facsimile device, and/or scanner can be attached locally to a workstation or to a server and be shared by network users.

Some of the network devices on a LAN and/or WAN may be “thinner” than the fully-loaded Windows or Mac machine. For example, diskless and floppy-only workstations have no local storage and retrieve all software and data from the server. Windows terminals are also used, which function only to display results from a central server. LANs and/or WANs can allow workstations to function as a server, allowing users access to data on another user's machine. These peer-to-peer networks are often simpler to install and manage, but dedicated servers provide better performance and can handle higher transaction volume. Multiple servers are used in large networks.

The controlling software in a LAN and/or WAN is the network operating system, e.g., Windows, Mac, Linux, and/or Unix, in the server. A component part can reside in a given client, or network device, and allow an application on the network device to read and write data from the server as if it were on the local machine.

A network device having processor logic and memory, such as the network devices described herein, includes an operating system layer and an application layer to enable the device to perform various functions or roles. The operating system layer includes a master control program that runs the network device. As understood by one of ordinary skill in the art, the master control program provides task management, device management, and data management, among others. The operating system layer communicates with program applications running thereon through a number of APIs. The APIs include a language and/or message format used by an application program to communicate with the operating system. The language and/or message format of the APIs allow an operating system to interpret executable instructions received from program applications in the application layer and return results to applications.

APIs are implemented by writing function calls in the program, which provide the linkage to the required subroutine for execution. There are more than a thousand API calls in a full-blown operating system such as Windows, Mac, or Unix.

Data transfer between devices over a network is managed by a transport protocol such as transmission control protocol/internet protocol (TCP/IP). The IP layer in TCP/IP, contains a network address and allows messages to be routed to a different network or subnetwork (subnet). The physical transmission is performed by an access method, e.g., Ethernet, which is on the motherboard or in the network adapter cards (NICs) plugged into the network devices. Ethernet is a widely used local area network (LAN) access method, defined by the IEEE as the 802.3 standard. The actual communications path is the twisted pair or optical fiber cable that interconnects each network adapter.

As mentioned above, network devices in a LAN and/or WAN include hardware components, such as trunk lines, switches, routers, hubs, servers, and databases. LANs and/or WANs can also include software, application modules, firmware, and other computer executable instructions operable thereon.

Network devices such as switches, hubs, and routers, for example, are used to distribute and restrict traffic within workgroups of a network. Network devices can also provide filtering of inter or intra network traffic for security purposes and policy management. These sorts of network device functionality can also be incorporated into other devices within a network environment, such a file server, a load balancing device or other such network appliance.

Any number of network devices, such as those mentioned above, may be included in a network. In some situations, network devices can go offline or malfunction. For example, during a power outage a network device may lose power and the network connection is lost. Additionally, a network device can become overloaded with information and can shut itself down to protect itself or can be overwhelmed by the information such that the network device becomes “frozen” or “crashes”. Furthermore, overloaded or malfunctioning devices may remain functional, but operate at a diminished capacity. In such cases, the data in transit through the network device can be damaged or lost.

Managing network communication between network devices in the network can be provided by various network protocols including, but not limited to, simple network management protocol (SNMP), common management information protocol (CMIP), distributed management environment (DME), telnet protocol, and internet control message protocol (ICMP) to name a few. ICMP is a TCP/IP protocol used to send error and control messages. A network device may use ICMP to notify a sender that its destination node is not available. For example, a ping utility sends ICMP echo requests to verify the existence of an IP address. The ping is used to identify a network device status, e.g., whether the network device is up or down.

Traditional network management applications only reveal whether a network device responds to this ICMP ping. That is, current network device status typically only shows red (down), yellow (trap received), or green (up). This only gives a partial view of the real health of the network device.

### BRIEF DESCRIPTION OF THE DRAWINGS

FIG. 1 is an embodiment of a computing device network.

FIGS. 2-3 illustrate various method embodiments for network and network device health monitoring.

### DETAILED DESCRIPTION

Computing device networks are becoming more and more functional, or intelligent, in terms of the services they can provide in cooperation with the software tools that are provided thereon. Embodiments of the present invention include program applications that execute instructions to harvest a wide range of information which is available from the devices attached to a network. Program application embodiments of the present invention execute instructions to transmit network management messages to network attached devices and collect response information from the network attached devices based on the network management messages. Additionally, however, the program application embodiments receive unsolicited information from network attached devices. The program application embodiments further execute instructions to analyze the response information and the unsolicited information according to a set of heuristics to provide a health measurement of the network devices which is more detailed than merely an up/down status indication. The program embodiments can additionally use the applied heuristics to determine a health of the network as a whole based on the solicited and unsolicited information received from the network devices.

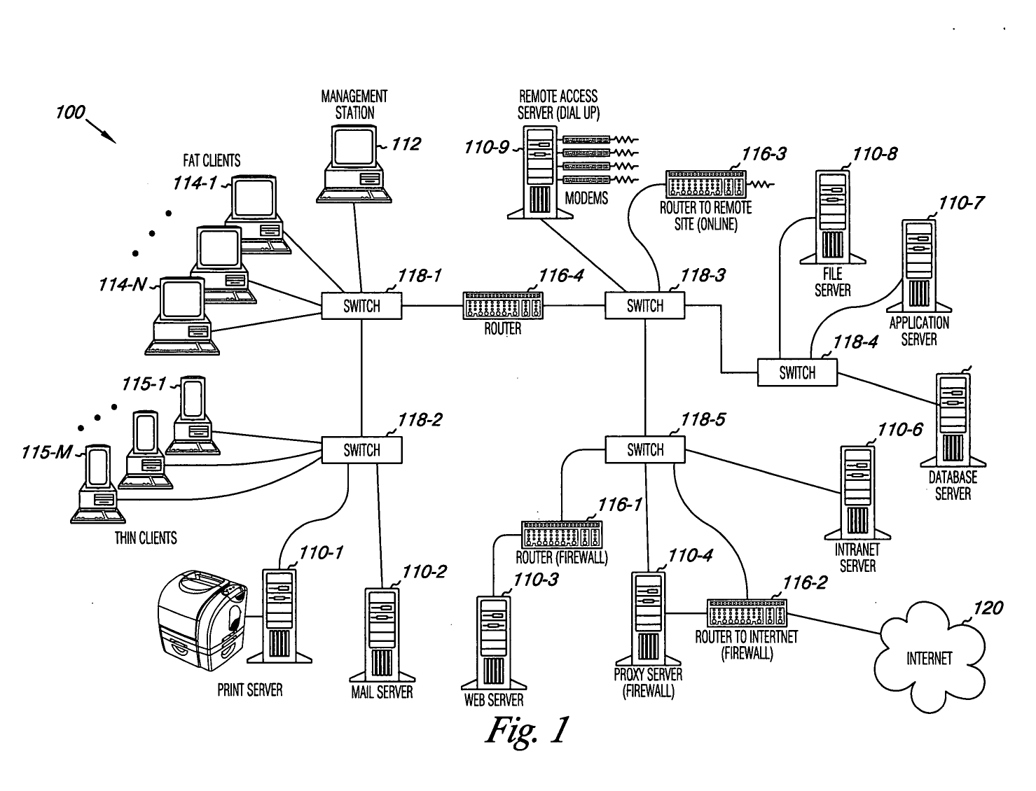

FIG. 1 is an embodiment of a computing device network 100. As shown in FIG. 1, a number devices can be networked together via a LAN and/or WAN via router, hubs, switches and the like. The embodiment of FIG. 1 illustrates client and servers in a LAN. However, embodiments of the invention are not so limited. The embodiment shows one server for each type of service on a LAN. However, in practice several functions can be combined in one device or machine and, for large volumes, multiple devices or machines can be used to balance the traffic for the same service. For example, an enterprise system or network can include a collection of servers, or server farm, cooperating to provide services to the network.

FIG. 1 illustrates a print server 110-1 to handle print jobs for the network 100, a mail server 110-2, a web server 110-3, a proxy server (firewall), a database server 110-5, and intranet server 110-6, an application server 110-7, a file server 110-8, and a remote access server (dial up) 110-9. Again, the examples provided here do not provide and exhaustive list. The embodiment of FIG. 1 further illustrates a network management station 112, e.g., a PC or workstation, a number of “fat” clients 114-1, . . . , 114-N which can also include PCs and workstations and/or laptops, and a number of “thin” clients 115-1, . . . , 115-M which can include terminals and/or peripherals such as scanners, facsimile devices, handheld multifunction device, and the like. The designators “N” and “M” are used to indicate that a number of fat or thin clients can be attached to the network 100. The number that N represents can be the same or different from the number represented by M. The embodiment of FIG. 1, illustrates that all of these example network devices can be connected to one another and/or to other networks via routers, 116-1, 116-2, 116-3, and 116-4, and hubs and/or switches 118-1, 118-2, 118-3, 118-4, and 118-5, as the same are know and understood by one of ordinary skill in the art. Embodiments of the invention, however, are not limited to the number and/or quantity of network devices in FIG. 1's illustration.

As one of ordinary skill in the art will appreciate, many of these devices include processor and memory hardware. By way of example and not by way of limitation, the network management station 112 will include a processor and memory as the same are well know to one of ordinary skill in the art. Embodiments of the invention are not limited, for the various devices in the network, to the number, type or size of processor and memory resources.

Program embodiments (e.g., computer executable instructions), as described in more detail below, can reside on the network management station 112. Embodiments, however, are not so limited. That is, a program embodiment can be resident on the network 100 in the memory of the network management station 112, and executable by the processor thereon. Additionally, however, the program embodiments can be resident elsewhere in the network 100 such as in a distributed computing network.

The program embodiments can execute instructions in conjunction with a network management program, which employs a protocol such as SNMP, ICMP, etc., to collect response information from the various network attached devices shown in FIG. 1. For example, the program embodiments execute instructions to collect response messages, and associated information, returned in response to network management messages sent as SNMP messages and/or ICMP pings. Additionally, however, the program embodiments execute instructions to receive unsolicited information from the various network devices shown in FIG. 1. As used herein, the unsolicited information includes messages which are initiated by a network attached device and not received in response to a particular request. For example, a network device may periodically initiate and transmit messages to a network management program which are not in response to an SNMP message or ICMP ping.

The unsolicited messages can include messages selected from the group of, messages reporting successful events, messages reporting the violation of a traffic threshold, and messages reporting a non-functioning component on a network attached device. One example includes receiving a message, e.g., initiated from a network device to a management program, which reports that a packet of data has been successfully sent from a port on the device. Another example includes receiving a message, initiated from a network device to a management program, which reports the device's processor utilization, memory utilization, link status, and local area network (LAN) utilization, among other information. This information when processed by the heuristic embodiments described below may reveal the device is over burdened with traffic and that the device may crash. Still another example includes receiving a message, initiated from a network device to a management program, which reports that a port on the device is not functioning. Upon reading this disclosure, one of ordinary skill in the art will appreciate that the embodiments of the invention are not limited to these examples.

The program embodiments execute instructions to collectively analyze both solicited and unsolicited information according to a set of heuristics, examples of which are explained in more detail below. That is, the program embodiments execute instructions to analyze response information, collected as solicited by a network management program employing a protocol such as SNMP, ICMP, etc, as parameters to an applied heuristic. And, the program embodiments execute instructions to analyze received, unsolicited information together with the solicited response information as parameters to the applied heuristic. As noted above, the unsolicited information can be contained in messages initiated from a particular network device to a management program or otherwise.

As one of ordinary skill in the art will appreciate, data can be passed from SNMP agents, which are hardware, firmware, and/or software processes, or combinations thereof, reporting activity in each network device (e.g., hub, switch, server, peripheral, router, workstation, laptop, etc.) to the management workstation 112. The agents can return information contained in a management information base (MIB) of the network attached device. The MIB is a data structure that defines what is obtainable from the device and what can be controlled, measured, or monitored, turned off, turned on, etc.

The applied heuristics enable the program embodiments to provide a health measurement of a particular network device and/or the network itself. The heuristics are related to various, diverse parameters. In various embodiments the set of parameters includes a set of parameters selected from the group of; device processor utilization (e.g., CPU utilization), device memory utilization, a link up/down status, statistics, including but not limited to, discards, CRC (cyclical redundancy checking) or FCS (frame check sequence) errors and number of broadcasts, a trap receipt, device and/or network buffer utilization, and other device and/or network error receipts. In this manner, the program embodiments can provide a health measurement of the device and/or network which is more than merely an up/down status indication.

One of ordinary skill in the art will appreciate upon reading this disclosure the manner in which device processor utilization, device memory utilization, a link up/down status, discards, CRC or FCS errors, trap receipts, device buffer utilization, and other device error receipts can be received. That is, this information can be received either in response to network management messages, e.g., SNMP messages and/or ICMP pings, or as unsolicited device message information sent from more intelligent network attached devices in more intelligent computing networks. One of ordinary skill in the art will further appreciate the utility of these various types of information. For example, receipt of an interrupt trap will cause instructions to wait for a particular interrupt to occur and then execute a corresponding routine in order to test for a particular condition in a running program. Receipt of an error trap includes instructions which execute to test for an error condition and to provide a recovery routine. And, a debugging trap includes instructions to wait for the execution of a particular instruction in order to stop the program and analyze the status of a system at that moment.

To analyze the solicited and unsolicited information the program embodiments execute instructions to compare the various parameters, such as listed above, to one or more thresholds. The thresholds can be selectably input and from time to time adjusted by a network administrator or other user. The thresholds can be selectably input using an input/output (I/O) mechanism, e.g., keyboard, mouse, voice recognition software, touch panel, etc. connected to a network management station or elsewhere in a computing network. The comparison of a given parameter to a threshold can be performed repeatedly over a period of time with variable frequencies and can be recorded for later retrieval in processing a health measurement of a particular network device and/or of the network itself.

Thus, received processor utilization information received from a particular device can be compared to one or more thresholds as part of an applied heuristic. Likewise, as part of an applied heuristic, received memory utilization information from a particular device can be compared to one or more thresholds. Furthermore, a link up/down status, trap receipt, buffer utilization, CRC or FCS errors and number of broadcasts, etc, as received from a particular device and/or the network can be included as parameters in an applied heuristic. Embodiments are not limited to these example parameters.

In applying the heuristics, the program embodiments can execute instructions to weight information for such various parameters as CPU utilization, memory buffer utilization, traps, etc, differently. For example, the program embodiments can execute to weight information using pre-determined weight values, scaling factors, or otherwise. As one of ordinary skill in the art will appreciate upon reading this disclosure, the program embodiments allow for a network administrator to use an I/O mechanism, as described above, to variably tailor a heuristic as to which different parameters of information are included, and as to the weighting and/or scaling factors applied to the included parameters as suited to a particular type of network attached device and/or as suited to a particular network. The program instructions, in applying a particular heuristic, can use the weight values or other scaling factors to measure and compile detail information on the health of the device.

The program embodiments apply these heuristics to formulate a more robust health measurement for various network attached devices than is yielded by separately assessing individual pieces of the solicited and unsolicited information. From the application of a particular heuristic, the program embodiments described herein can execute instructions to provide the resulting measurements and compiled health information to a user on the network, e.g., a network administrator, in a format which is significantly more informative than programs which just collect a link up/down status and/or incorporate traps alone. In addition to providing a higher level of detail or granularity pertaining to the health of network devices and/or the network itself, program embodiments can execute instructions to suggest or even automatically initiate actions to preemptively avoid deleterious network events, e.g. a device or network crash.

To further illustrate, by way of example and not by way of limitation, program embodiments can execute instructions to register that a particular port on a particular (first) network device, e.g., a print server, a switch, a file server, a hub, or other network appliance, has just successfully sent a packet of data as a parameter in an applied heuristic. Additionally, the program embodiments can execute instructions to register, as a related parameter in the heuristic, that the first network device has reported that the data traffic through its ports is presently light or that the device is being under utilized. In a relatively proximate time frame, the program embodiment can similarly execute instructions which register that a port on another network (second) device, e.g., a different print server, file server, switch, hub, etc., is reporting that the data traffic through its ports is high, that the second device is overburdened (e.g., based on applying heuristic which weights device parameters such as CPU utilization and memory buffer utilization for example), and/or that a particular port on the second device is currently inoperable (e.g., including in the applied heuristic parameters such as received traps, link errors, and/or other status indicators). The program embodiments can use the health measurements, resulting from the applied heuristic, and execute instructions to provide additional detail and/or alert indications to a user, e.g., network administrator, concerning the potential issues of this situation in advance of the second device becoming frozen or crashing. In some program embodiments, the program executes instructions to restrict data traffic to the second device with the ports which are overburdened or non-functioning and/or to reroute data traffic from the second device to the first device which is being underutilized and/or having ports experiencing light traffic. Again, embodiments of the invention are not limited to these examples.

The program embodiments providing these heuristics may be used to determine the health of the network, as well as the health of individual network devices. One of ordinary skill in the art will appreciate the manner in which the program embodiments, as described herein, can be provided to the network 100. One example includes loading the programs from a floppy disk, CD, or other medium of the like and in order to perform a software and/or firmware update to a device on the network 100, e.g., a network management station. Similarly, the program embodiments can be downloaded from a remote source over a network connection such as the Internet. Embodiments, however, are not limited to these examples.

In conjunction with the program embodiments, icons can be presented on a display, e.g., a display of a network management station. Each icon can be displayed in various color codes which represent the measurements and calculated results from a particular applied heuristic in order to visually indicate the health of a particular network attached device and in order to visually indicate a problem to be avoided on the device and/or network. As one of ordinary skill in the art will appreciate, the various color codes can include a much wider variety of indicator colors than the three colors of red (device down), yellow (trap received), and green (device up) that have been used in previous network management approaches. In various embodiments a number of different colors and shades are used to accommodate the added degrees of health measured for a network device by the applied heuristics. For example, the use of color gradients, textured patterns, and/or multi-part coloring of the icons, rather than just basic colors, can be provided to represent different parameters (e.g. CPU utilization, memory utilization, broadcasts, discards, CRC and FCS errors, etc.) of the health of the device. Again, embodiments of the invention are not limited to these particular visual indication examples.

Furthermore, the program embodiments can execute instructions such that when a given icon is selected additional levels of detail or granularity, e.g. additional report information, on the health of a particular network device is provided. Thus, upon selecting a particular icon which is of interest the program embodiments can execute instructions to reveal in greater detail the reasons behind why the device has a particular health status, e.g., why CPU, memory, or LAN utilization is high causing a particular device to be overburdened and/or a candidate to crash.

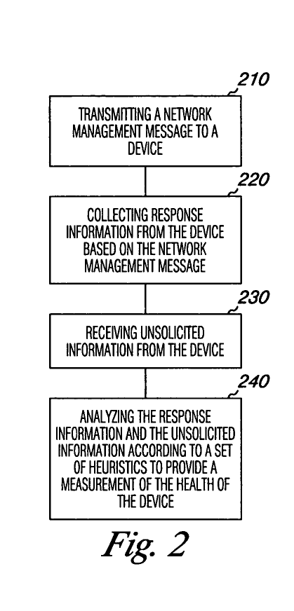

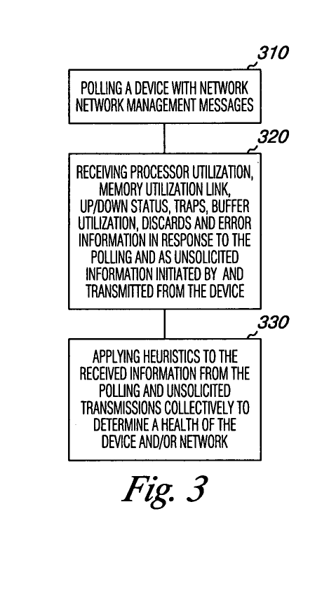

FIGS. 2-3 illustrate various method embodiments for network and network device health monitoring. As one of ordinary skill in the art will understand, the embodiments can be performed by software, application modules, and computer executable instructions operable on the systems and devices shown herein or otherwise. The invention, however, is not limited to any particular operating environment or to software written in a particular programming language. Software, application modules and/or computer executable instructions, suitable for carrying out embodiments of the present invention, can be resident in one or more devices or locations or in several devices and location in a network.

Unless explicitly stated, the method embodiments described herein are not constrained to a particular order or sequence. Additionally, some of the described method embodiments can occur or be performed at the same point in time.

FIG. 2 illustrates a method embodiment associated with network and network device health monitoring. In the embodiment of FIG. 2, the method includes transmitting a network management message, e.g., an SNMP, ICMP, or other similar message as the same are know and understood by one ordinary skill in the art, to a device as shown in block 210. The device can be coupled to a network management station over a LAN and/or WAN, including wired and wireless network environments. The network management message is transmitted and pertains to a network port on the device. In various embodiments, a network management station includes a network management program application to transmit an SNMP message, for example, to the network attached device. In various embodiments, such a management program application executes instructions to use the SNMP message to query a device and retrieve MIB data.

In block 220, the method includes collecting response information from the device based on the network management message. One of ordinary skill in the art will appreciate the manner in which response information may be returned, e.g., to a network management program on a network management station, in response to a network management message.

In block 230, the method includes receiving unsolicited information from the device. Again, one of ordinary skill in the art will appreciate the manner in which unsolicited information may be received from a device, e.g., sent to a network management program on a network management station by an intelligent network device. As described in detail above, receiving unsolicited information from the device can include receiving information relating to; processor utilization, memory utilization, local area network utilization, statistics including discards, CRC or FCS errors, etc., and other associated errors. Further receiving unsolicited information from the device includes receiving messages selected from the group of; messages reporting successful events, messages reporting a traffic threshold, and messages reporting a non-functioning component on the device.

In block 240, the method includes analyzing the response information and the unsolicited information according to a set of heuristics to provide a measurement of health for the device and/or network. As used herein, a measurement of health can include a positive or a negative indication of health for the device, or even both, e.g., some positive indications (such as an up link status) and some negative indications (such as very high CPU or memory utilization) as to the health of the device or network. And, as used herein, an applied heuristic includes parameter information which can serve to indicate, point out, and/or evaluate network and network device health, among other things. As described in detail above, the set of heuristics can include various parameters such as processor utilization, memory utilization, link up/down status, trap receipt, buffer utilization, broadcasts, discards, CRC and FCS error receipts, etc. The heuristics can include customization of a weight or significance, e.g., interpretation, applied to these various parameters. Embodiments, however, are not limited to these example parameters.

In one example, the program instructions execute and apply a heuristic to weight a combination of received parameters, e.g., solicited and unsolicited information, from a network attached hub. Unsolicited information, in this example, can include the case where the network attached hub device initiates and transmits CPU usage information, memory buffer utilization, statistics including discards, CRC or FCS errors, and traps. This unsolicited information can be received by the program embodiments. For example, the hub device can initiate and transmit CPU usage, memory buffer utilization, discards, CRC or FCS errors, and traps to a general network management program and the program embodiments can execute to retrieve this information from the same. Embodiments, however, are not limited to this example.

Solicited information, in this example, can include return messages to SNMP messages including return information contained in a management information base (MIB) of the hub device. The solicited information can additionally include return messages relating to ICMP pings sent from a network monitoring program to the hub device. It is noted that the embodiments are not dependent on how the program receives the solicited and unsolicited information. However, it is noted that the applied heuristic can incorporate parameters which include more than just and up/down status and/or traps. That is, the program embodiments execute to apply a heuristic relating to parameters which are not all in response to the active solicitation by a network management program using an SNMP and/or ICMP protocol.

In one example of the applied heuristic, the program embodiments register that the hub device has initiated and transmitted information indicating its CPU usage is at 90% and its memory buffer utilization is above 80%. In this example, the program embodiments can further register that a certain number and type of traps have been received. Based on an applied heuristic using these parameters and/or other parameters, the program embodiments execute to produce a health measurement for the device. The program embodiment, in executing its instructions to apply a particular heuristic using these parameters for the hub device, may produce a health measurement which indicates that the hub is at risk of being overloaded. Conversely, if the program receives information from the hub device that its CPU usage is above 80% (for a continued period of time) but has not exceeded 90%, that the buffer utilization is above 80%, but no traps have been received, then in executing its instructions to apply a particular heuristic using these parameters for the hub device the program may produce a health measurement which indicates a cautionary warning to continue monitoring the hub at a particular increased interval.

It is noted that embodiments of the invention are not limited to the above percentage and value examples. As one of ordinary skill in the art will appreciate, various network attached devices can have different tolerances and capacities. An analogy can be drawn between the network and network device health to that of human health. That is, the human body can tolerate a number of different potential problems which jeopardize health, but which are not outwardly apparent. In the human arena, an intelligent medical scan of an individual will point out potential problems which can be proactively addressed. In an analogous manner, the program embodiments by applying a heuristic incorporating solicited and unsolicited information as parameters can reveal a health measurement for the network and/or network attached device which is not outwardly apparent from just SNMP messages and/or ICMP pings, e.g., an up status by itself will not reveal the true health of a network attached device.

For example, a network device may be completely functional, in that it is forwarding and filtering traffic without errors or loss of data. However, the CPU utilization and memory usage of the device may be such that the device is, in actuality, on the brink of collapse. Only a minor increase in traffic will cause the device to become overburdened and unable to function at its desired capacity; or worse, it is susceptible to a crash. The program embodiments, as described herein, by applying a heuristic incorporating solicited and unsolicited information as parameters, can reveal a health measurement for the network and/or network attached device that is based on analysis of pertinent parameters and information. And, the program embodiments can execute to display the health of the device in a detailed fashion and/or initiate further network actions so that a potential device and/or network problem can be averted.

Another example would be the use of FCS or CRC statistics to determine that the network is suffering from the transmission of illegal frames onto its bandwidth. This problem may go unnoticed if the rudimentary device polling of SNMP and/or ICMP pings is used. However, program embodiments applying a heuristic which incorporates this sort of information as parameters, can reveal a health measurement to detect and indicate the presence of such illegal frames, and a potential issue relating to the same can be observed and corrected.

FIG. 3 illustrates another method embodiment for network device health monitoring. According to various embodiments, the method can be used for network and network device monitoring. In the embodiment of FIG. 3, the method includes polling a device with network management messages at block 310. In block 320 the method includes receiving processor utilization, memory utilization, link up/down status, traps, buffer utilization, discards, and error information in response to the polling and as unsolicited information initiated by and transmitted from the device. In block 330, the method includes applying heuristics to the received information from the polling and unsolicited transmissions collectively to determine a health of the device and/or network.

As used herein, applying heuristics includes using the received information as parameters to the applied heuristic. As one of ordinary skill in the art will appreciate upon reading this disclosure, examples of an applied heuristic for analyzing and weighting various parameters can include the examples given above in connection with FIG. 2. However, embodiments of the invention are not limited to the examples given herein. One of ordinary skill in the art will appreciate upon reading this disclosure the variety of heuristics which may be applied as suited to different network devices and/or network environments to capitalize on both collected network management messages and received, unsolicited device information to more robustly determine the health of a network device and/or network than is afforded by just collecting an up/down status and/or incorporating traps alone.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A network management station, comprising:
a processor;
a memory coupled to the processor; and
program instructions provided to the memory and executable by the processor to:
transmit a network management message to a device connected to the network management station over a network;
collect response information from the device based on the network management message;
receive unsolicited information from the device; and
analyze the response information and the unsolicited information according to a set of heuristics to provide a health measurement of the device.

2. The station of claim 1, further including program instructions that execute to compare device processor utilization, device memory utilization, local area network (LAN) utilization, errors, and trap information with one or more thresholds as parameters to the set of heuristics.

3. The station of claim 1, wherein the set of heuristics include as parameters; processor utilization, memory utilization, LAN utilization, statistics including discards, cyclical redundancy checking (CRC) and frame check sequence (FCS) errors and number of broadcast, and traps, received as both solicited and unsolicited messages from the device.

4. The station of claim 1, further including program instructions that execute to analyze unsolicited messages initiated from the device to a management program, the unsolicited messages selected from the group of:
messages reporting successful events;
messages reporting a traffic threshold; and
messages reporting a non-functioning component on the device.

5. The station of claim 1, further including program instructions that execute to collectively analyze all of the information, both solicited and unsolicited, in order to formulate a health measurement for the device and for the network.

6. The station of claim 1, further including program instructions that execute to assign pre-selected weight values to the collected and received information as part of an applied heuristic and to use the weight values to provide the health measurement.

7. The station of claim 6, further including program instructions that execute to initiate network actions, based on the health measurement, to avoid potential issues with the device and the network.

8. The station of claim 1, further including program instruction that execute to implement different weight values to solicited and unsolicited information as parameters to the set of heuristics as suited to a particular type of network device.

9. The station of claim 1, further including program instruction that execute to implement different weight values to solicited and unsolicited information as parameters to the set of heuristics as suited to a particular type of network.

10. The station of claim 1, wherein the device and the station are connected over a local area network (LAN).

11. The station of claim 1, wherein the device and the station are connected over a wide area network (WAN).

12. A network management station, comprising:
a processor;
a memory coupled to the processor; and
program instructions provided to the memory and executable by the processor to:
poll a device, connected to the station over a network, with network management messages;
receive processor utilization, memory utilization, link up/down status, trap, buffer utilization, discard and error information in response to the polling and as unsolicited information initiated by and transmitted from the device; and
apply heuristics to the received information from the polling and unsolicited transmissions collectively to determine a health of the device.

13. The station of claim 12, further including program instructions which execute to display a visual indicator of the health of the device.

14. The station of claim 13, further including program instructions which execute to display additional detail report information upon a selection of the visual indicator.

15. The station of claim 12, further including program instructions that execute to register, as a parameter to the applied heuristics, that the data traffic through a port of the device is being under utilized.

16. The station of claim 15, further including program instructions that execute to register, as a parameter to the applied heuristics, that the data traffic through a port on another network device is overburdened.

17. The station of claim 16, further including program instructions that execute to initiate an action based on the determined health of device in order to avoid a problem on the device and the network.

18. A method for network and network device monitoring, comprising:
transmitting a network management message to a device;
collecting response information from the device based on the network management message;
receiving unsolicited information from the device; and
analyzing the response information and the unsolicited information according to a set of heuristics to provide a health measurement for the device.

19. The method of claim 18, wherein the method further includes transmitting an SNMP message to the device.

20. The method of claim 19, wherein the method further includes receiving return information contained in a management information base (MIB) of the device.

21. The method of claim 18, wherein the method further includes transmitting an ICMP ping to the device.

22. The method of claim 18, wherein the method further includes receiving information using a telnet protocol.

23. The method of claim 18, wherein the method further includes receiving traps from the device.

24. The method of claim 18, wherein receiving unsolicited information includes unsolicited information relating to:
processor utilization;
memory utilization;
local area network utilization; and
errors.

25. The method of claim 18, wherein receiving unsolicited information from the device includes receiving messages initiated from the device to a management program, including messages selected from the group of:
messages reporting successful events;
messages reporting a traffic threshold; and
messages reporting a non-functioning component on the device.

26. The method of claim 18, wherein the method further includes receiving a message, initiated from the device to a management program, which reports that a packet of data has been successfully sent from a port on the device.

27. The method of claim 18, wherein the method further includes receiving a message, initiated from the device to a management program, which reports that the device is over burdened with traffic and may crash.

28. The method of claim 18, wherein the method further includes receiving a message, initiated from the device to a management program, which reports that a port on the device is not functioning.

29. The method of claim 18, wherein analyzing according to a set of heuristics includes a heuristic having parameters selected from the group of:
a processor utilization;
a memory utilization;
a link up/down status;
a trap receipt;
a buffer utilization;
a discard receipt;
a CRC statistic; and
a FCS statistic.

30. A method for network and network device monitoring, comprising:
polling a device with network management messages;
receiving processor utilization, memory utilization, link up/down status, trap, buffer utilization, and error information in response to the polling and as unsolicited information initiated by and transmitted from the device; and
applying heuristics to the received information from the polling and unsolicited transmissions collectively to determine a health of the device and the network.

31. The method of claim 30, wherein the method further includes displaying a visual indicator of the determined health.

32. The method of claim 31, wherein the method further includes accessing additional report information by selecting the visual indicator.

33. A computer readable medium having instructions for causing a device to perform a method, comprising:
transmitting a network management message to a device;
collecting response information from the device based on the network management message;
receiving unsolicited information from the device; and
analyzing the response information and the unsolicited information according to a set of heuristics to provide a health measurement of the device.

34. A network management station, comprising:
a processor;
a memory coupled to the processor;
means for receiving solicited and unsolicited information from a network device, the unsolicited information initiated by and transmitted from the device, the information including processor utilization, memory utilization, link up/down status, trap, buffer utilization, and error information; and
means for analyzing the received information collectively to provide a health measurement of the device.

35. The station of claim 34, wherein the means for receiving solicited information includes executing instructions to send a simple network management protocol (SNMP) query to the device.

36. The station of claim 34, wherein the means for receiving unsolicited information initiated by and transmitted from the device includes executing program instructions to record the unsolicited information and to apply the unsolicited information as parameters in a heuristic analysis.

37. The station of claim 34, wherein the heuristic analysis includes program instructions that execute to assign pre-selected weight values to the solicited and unsolicited information to provide the health measurement.

38. The station of claim 37, further including program instructions that execute to initiate network actions based on the health measurement.

39. The station of claim 38, further including program instruction that execute selectively modify one or more parameters in the heuristic analysis as suited to a particular type of network work and a particular type of network device.
